(19) United States
(12) Patent Application Publication
(10) Pub. No.: US 2008/0206068 A1
(43) Pub. Date: Aug. 28, 2008

(54) CONCRETE PUMP ATTACHMENT

(76) Inventor: Donald S. Nadler, Blue Springs, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/037,068

(22) Filed: Feb. 25, 2008

Related U.S. Application Data
(60) Provisional application No. 60/891,449, filed on Feb. 23, 2007.

(51) Int. Cl. F16L 55/02; B05B 1/00; F16L 55/027

(52) U.S. Cl. 417/53; 138/40; 239/589; 222/545

(57) ABSTRACT

A attachment for a concrete pump is provided. The attachment includes a generally tubular outer body including an open top end and bottom end. The attachment is connected at its top end to the discharge hose of a concrete pump. A deflection member is located within body and gaps are provided between the deflection member and the inner walls of the body.

### CROSS-REFERENCE TO RELATED APPLICATIONS

This application claims priority pursuant to 35 U.S.C. 119(e) to co-pending U.S. Provisional Patent Application Ser. No. 60/891,449, filed Feb. 23, 2007, the entire disclosure of which is incorporated herein by reference.

### FIELD OF THE INVENTION

The present invention relates to devices for pumping concrete. More particularly, the present invention relates to an attachment for a concrete pump.

### BACKGROUND OF THE INVENTION

Concrete is an important building material in many construction projects. Concrete is made by mixing aggregates and sand with a binding agent (usually cement) and, if necessary, with additives. All of the raw materials for concrete production are typically brought together in a mixer at a concrete plant, where they form a homogenous concrete mixture. The wet (plastic) concrete is then transported to construction sites in cement trucks equipped with revolving drums (mixer trucks).

In many instances the location in which the wet concrete is to be poured is difficult or impossible to be accessed by a mixer truck. In such instances a concrete pump truck is typically used to pump the wet concrete to the desired location. The wet concrete is loaded from the mixer truck to a hopper in the pump truck and then pumped through a series of large pipes/hoses connected to a boom on the pump truck. The end of the pipes/hoses opposite the hopper is open and positioned at the location in which the wet concrete is needed so that the concrete mixture is discharged from the open end of the pipes/hoses. Typically, the end piece of pipes/hoses is a generally pliable material (such as rubber or other suitable material) to allow easier manipulation by a worker directing the flow of concrete to a specific desired location.

When concrete is pumped to a location, the concrete is discharged from the end of the pipes/hoses at a relatively high velocity. The high velocity results in a thrust force on the pipes/hoses as the concrete mixture is discharged, making the position of the hose difficult to control and causing the hose to bounce around out of control if not securely held by a worker. In addition, the high velocity discharge often results in splattering of the concrete as well as displacing of forms. In particular, in the context of tilt-up construction it is often desirable to construct concrete walls having items (such as bricks) loosely embedded within the walls. Such walls are often constructed by placing the items (e.g. bricks) in holes within a form and then pouring wet concrete over the form. Often, when concrete is pumped into such forms, the thrust of the concrete being discharged from the discharge hose of the pump will dislodge some of the items from the form. As a result, the dislodged item must be chiseled out from the concrete wall once it has hardened and replaced, adding considerably to the time and expense of construction. Therefore, it would be beneficial to reduce the velocity of wet concrete as it is being discharged from the discharge of a pump.

### SUMMARY OF THE INVENTION

An object of the present invention is to reduce the velocity of wet concrete as it is being discharged from the discharge of a pump. Another object of the present invention is to reduce splatter and/or displacing of forms when concrete is discharged from a pump. Still another object of the present invention is to provide a pump attachment for reducing the velocity of wet concrete as it is discharged from a pump. Yet another object of the instant invention is to provide a method of pumping concrete that results in reduced splatter and/or reduced displacement of forms. Still another object of the instant invention is to reduce the thrust force created by the discharge of concrete from the discharge hose/pipe of a pump.

The present invention comprises an attachment for a concrete pump that attaches to an end of a discharge hose of the concrete pump. This attachment slows the discharge velocity of the concrete from the pump when pumping concrete. The slowed discharge results in lower thrust force, less splatter, and when using attached forms lessens the possibility of displacing the forms (such as brick, reveal, and other form liners).

The attachment of a preferred embodiment of the instant invention includes an outer body including an open top end and bottom end. The attachment is connected at its top end to the discharge hose of a concrete pump. A deflection member is located within body and gaps are provided between the deflection member and the inner walls of the body. The attachment is connected to the discharge hose and concrete is pumped through the attachment. As the flow of concrete pumps through the attachment the concrete flow is deflected by the deflection member towards the gaps between the deflection member and the inner walls of the body. The deflection of the concrete from the deflection member slows the discharge velocity of the concrete and reduces the thrust on the operator of the discharge hose. The concrete continues to flow through the attachment and out the open bottom end. In a preferred embodiment the bottom end of the attachment includes a generally conical shape to assist in reducing the fall or thrust of the concrete as it exits the attachment.

Although the attachment of the instant invention reduces the velocity of concrete being discharged from a pump, it will be appreciated that the volume flow rate of the wet concrete may be maintained at the same rate as is obtained without using the attachment of the instant invention by appropriately manipulating the size and shape of the body, deflection member and gaps between the deflection member and inner walls of the body. Furthermore, it will be appreciated that the size and shape of any or all of the body, deflection member and gaps may be manipulated to obtain any number of desired volumetric flow rates, velocity, thrust or any other desired discharge characteristics.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 shows front elevation cross-section of a concrete pump attachment of a first embodiment of the instant invention.

FIG. 2 shows a cross-section of the pump attachment taken along line A of FIG. 1.

FIG. 3 shows a front elevation cross-section of a concrete pump attachment of a second embodiment of the instant invention.

FIG. 4 is a perspective view of a concrete pump attachment of another embodiment of the instant invention.

### DETAILED DESCRIPTION OF A PREFERRED EMBODIMENT

As required, a detailed embodiment of the present inventions is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

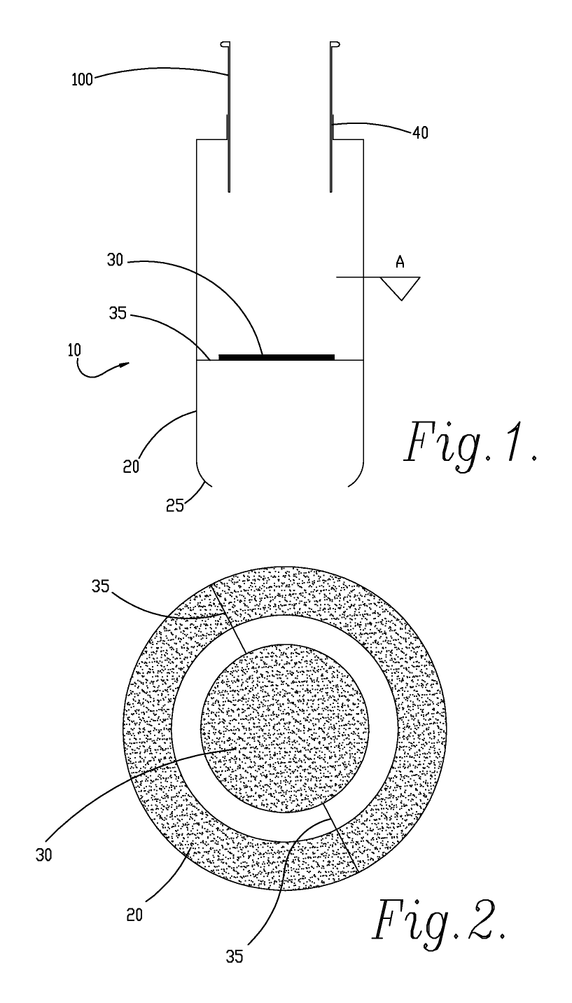

Referring to FIGS. 1 and 2, a first embodiment of the pump attachment of the instant invention is shown and described. Attachment 10 includes a generally tubular outer body 20 that is connected at its top end to the discharge hose (100) of a concrete pump with a clamp (40). Plate (deflection member) 30 is located within the tubular body (20) and connected to the inner walls of the tubular body via rod 35. In the preferred embodiment, body 20, plate 30 and rod 35 are all made of metal and welded together; nevertheless, it will be appreciated that alternative materials and methods of manufacturing may be utilized without departing from the spirit and scope of the instant invention.

In use, attachment 10 is connected to discharge hose 100 and concrete is pumped through attachment 10. As the flow of concrete pumps through attachment 10 the concrete flow is deflected by plate 30 towards the gaps between plate 30 and the inner walls of body 20. The deflection of the concrete from plate 30 slows the discharge velocity of the concrete and reduces the thrust on the operator of the discharge hose. The concrete continues to flow through attachment 10 and out open end 25. As is shown in FIG. 1, open end 25 includes a generally conical shape to assist in reducing the fall or thrust of the concrete as it exits attachment 10.

In an one exemplary embodiment of the embodiment of the invention shown in FIGS. 1 and 2 in which attachment 10 is designed for use with a 4 inch diameter discharge hose (100) from a pump, outer body 20 has a diameter of roughly 12 inches and is approximately 12 inches long. The discharge hose is positioned approximately 2 inches into attachment 10 and claimed into place. Plate 30 is located approximately 6 inches from the top of attachment 10 and has a generally circular shape having a diameter of approximately 7 inches, leaving approximately a 2½ inch diameter gap between plate 30 and the inner walls of body 20. The walls of body 20 curve inward toward open end 25 leaving an opening of having a diameter of approximately 9 inches.

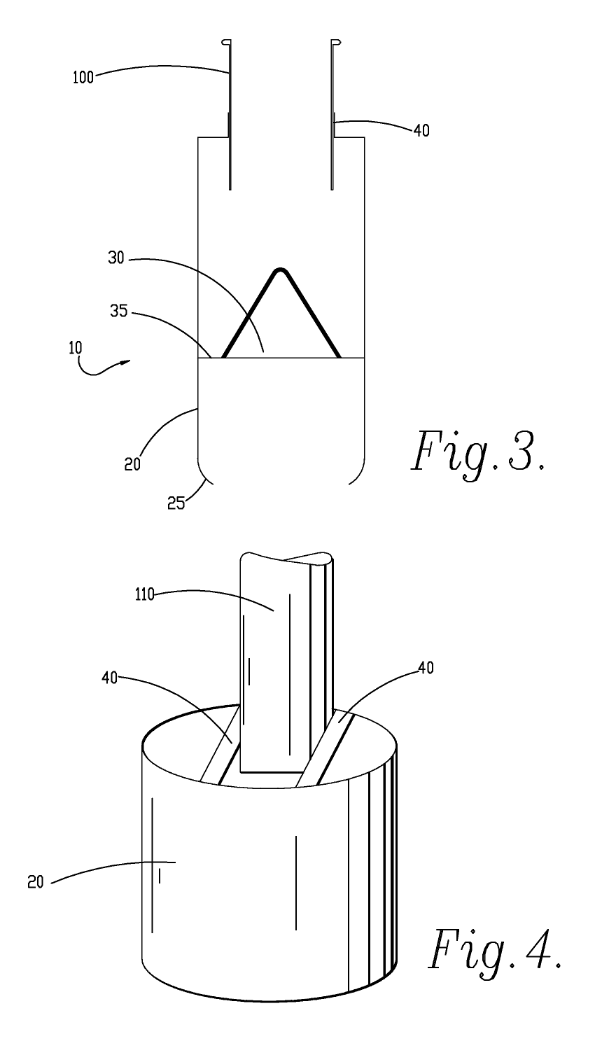

FIG. 3 shows a second embodiment of pump attachment 10 in which deflection member 30 includes a generally conical shape. Conical deflection member 30 is connected to the inner walls of body 20 via rod 35. In the embodiment shown in FIG. 3, the top point of conical deflection member 30 is directed upward toward into the oncoming flow of concrete through attachment member 10 such that the deflection of concrete will occur more gradually than is the case with the generally flat generally circular plate shown in FIGS. 1 and 2. Nevertheless, it will be appreciated that alternative orientations of conical deflection member 30 may be utilized without departing from the spirit and scope of the instant invention. Furthermore, it will be appreciated that numerous alternative sizes and shapes of deflection member 30 in addition to the conical and circular shapes disclosed herein may be utilized without departing from the spirit and scope of the instant invention.

FIG. 4 shows another embodiment of the pump attachment of the instant invention. The pump attachment shown in FIG. 4 may be constructed in a manner similar to that described above with respect to the embodiments shown in FIGS. 1-3, the primary difference being the inclusion of a concrete pump pipe (110) attached to the top end of attachment 10. Attachment 10 includes a generally tubular outer body 20 that is connected at its top end to pipe 110 which is then connected the discharge hose/pipe of a concrete pump. In the embodiment shown, pipe 110 is welded to cross-member clamps 40. Deflection member 30 (not shown in FIG. 4) is located within the tubular body (20) and connected to the inner walls of the tubular body via rod 35 (not shown in FIG. 4). In the preferred embodiment, body 20, deflection member 30, pipe 110 and rod 35 are all made of metal and welded together; nevertheless, it will be appreciated that alternative materials and methods of manufacturing may be utilized without departing from the spirit and scope of the instant invention.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. An attachment for a concrete pump comprising:
a body including a top opening and a bottom opening;
a deflection member within said body between said top opening and said bottom opening; and
a gap between said deflection member and an inner wall of said body.

2. The attachment as claimed in claim 1 further comprising a rod connecting said deflection member to said inner wall of said body.

3. The attachment as claimed in claim 1 wherein said body includes a generally tubular shape.

4. The attachment as claimed in claim 1 wherein said deflection member is a generally flat generally circular plate.

5. The attachment as claimed in claim 1 wherein said deflection member includes a generally conical shape.

6. The attachment as claimed in claim 1 wherein a bottom portion of said body includes tapering shape.

7. The attachment as claimed in claim 6 wherein said body includes a generally tubular shape and said bottom portion includes a generally conical shape.

8. The attachment as claimed in claim 1 further comprising a clamp connecting said attachment to a hose or tube.

9. A method of pumping concrete comprising the steps of:
discharging wet concrete from a hose or tube;
directing said discharged concrete into an attachment body;
deflecting said discharged concrete from a deflection member within said body;
allowing said deflected concrete to exit said attachment body.
